(19) United States
(12) Patent Application Publication
(10) Pub. No.: US 2015/0043205 A1
(43) Pub. Date: Feb. 12, 2015

(54) LIGHT-EMITTING DEVICE

(71) Applicant: Lextar Electronics Corporation, Hsinchu (TW)

(72) Inventor: Kuo-Chung Wei, Hsinchu County (TW)

(73) Assignee: Lextar Electronics Corporation, Hsinchu (TW)

(21) Appl. No.: 14/151,904

(22) Filed: Jan. 10, 2014

(30) Foreign Application Priority Data
Aug. 9, 2013 (TW) 102128711

(51) Int. Cl. F21S 4/00

(52) U.S. Cl. CPC F21S 4/003
USPC 362/223; 362/217.14

(57) ABSTRACT

A light-emitting device comprising a string-shape circuit board, several light-emitting elements, a first terminal pair and a second terminal pair is provided. The string-shape circuit board has a first side and a second side. The first terminal pair and the second terminal pair are disposed on the first side and the second side respectively, and are electrically connected to the light-emitting elements. The first terminal pair comprises a first base, a second base, a first positive electrode and a first negative electrode. The first positive electrode and the first negative electrode are pivotally connected to the first base and the second base respectively. The second terminal pair comprises a third base, a fourth base, a second positive electrode and a second negative electrode. The second positive electrode and the second negative electrode are pivotally connected to the third base and the fourth base respectively.

This application claims the benefit of Taiwan application Serial No. 102128711, filed Aug. 9, 2013, the subject matter of which is incorporated herein by reference.

### BACKGROUND OF THE INVENTION

1. Field of the Invention

The invention relates in general to a light-emitting device, and more particularly to a light-emitting device whose electrode terminals are disposed on a circuit substrate.

2. Description of the Related Art

Each electrode terminal pair of conventional lamp tube is integrated with a lamp cap. For each terminal pair of lamp cap to be electrically connected to an LED, conductive wires must be manually soldered onto the electrode terminal pair of the lamp cap. However, the structure of such lamp cap is complicated and is difficult to design, and the process of manually soldering conductive wires is time consuming and has high defect rate.

### SUMMARY OF THE INVENTION

The invention is directed to a light-emitting device whose electrode terminals are disposed on a circuit substrate, hence reducing structural complexity of a lamp cap.

According to one embodiment of the present invention, a light-emitting device is provided. The light-emitting device comprises a string-shape circuit board, several light-emitting elements, a first terminal pair and a second terminal pair. The string-shape circuit board has a first side and a second side, wherein a first surface and a second surface parallel and opposite to each other are disposed between the first side and the second side. A center of the circuit substrate extending towards the first side is defined as a first direction, and a center of the circuit substrate extending towards the second side is defined as a second direction. The light-emitting elements are disposed on the first surface of the circuit substrate. The first terminal pair and the second terminal pair are disposed on the first surface of the first side and the second side of the circuit substrate and are electrically connected to the light-emitting elements. The first terminal pair comprises a first base, a second base, a first positive electrode and a first negative electrode. The first positive electrode and the first negative electrode are pivotally connected to the first base and the second base respectively and able to be freely rotated between the first direction and the second direction. The second terminal pair comprises a third base, a fourth base, a second positive electrode and a second negative electrode. The second positive electrode and the second negative electrode are pivotally connected to the third base and the fourth base respectively and able to be freely rotated between the first direction and the second direction.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1 is an explosion diagram of a light-emitting device according to an embodiment of the invention.

FIG. 2 is a combination diagram of FIG. 1.

FIG. 3 is a cross-sectional view of the first end cap of FIG. 2.

### DETAILED DESCRIPTION OF THE INVENTION

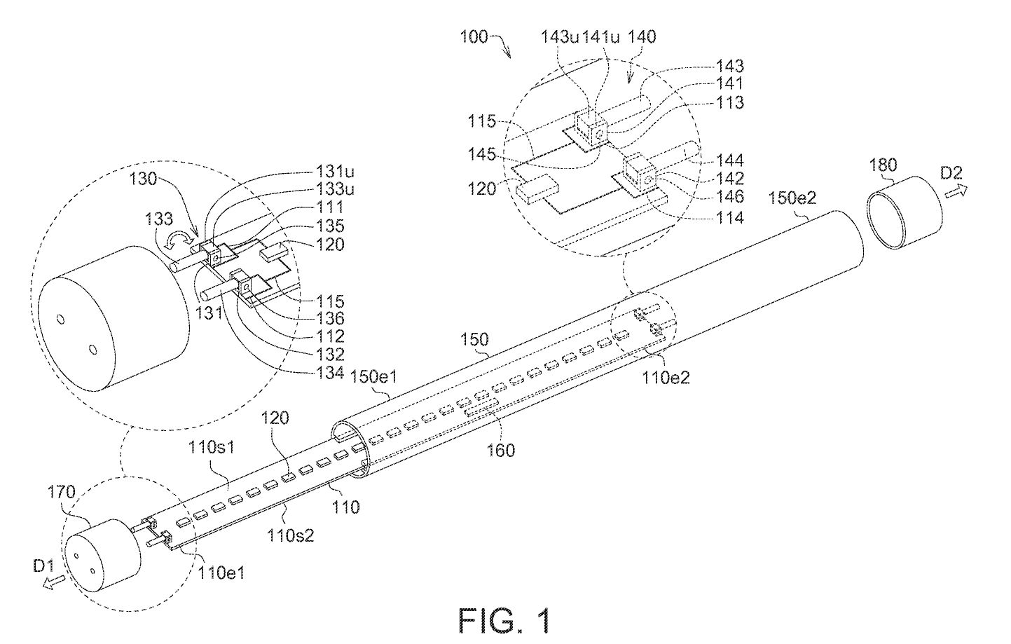

FIG. 1 is an explosion diagram of a light-emitting device according to an embodiment of the invention. The light-emitting device 100, such as a lamp tube, comprises a string-shape circuit board 110, a first solder pad 111, a second solder pad 112, a third solder pad 113, a fourth solder pad 114, several light-emitting elements 120, a first terminal pair 130, a second terminal pair 140, a transparent hollowed tube 150, a drive power 160, a end cap 170 and a second end cap 180.

The string-shape circuit board 110 has a first side 110e1 and a second side 110e2. A first surface 110s1 and a second surface 110s2, parallel and opposite to each other, are disposed between the first side 110e1 and the second side 110e2. A center of the string-shape circuit board 110 extending towards the first side 110e1 and the second side 110e2 are defined as a first direction D1 and a second direction D2 respectively.

The light-emitting elements 120, such as light-emitting diodes (LEDs), are disposed on the first surface 110s1 of the string-shape circuit board 110.

The first terminal pair 130 is disposed on the first surface 110s1 of the first side 110e1 of the string-shape circuit board 110 by using the surface mounting technology (SMT), and is electrically connected to the light-emitting elements 120. The first terminal pair 130 comprises a first base 131, a second base 132, a first positive electrode 133 and a first negative electrode 134. The first positive electrode 133 and the first negative electrode 134 are pivotally connected to the first base 131 and the second base 132 respectively and can be freely rotated between the first direction D1 and the second direction D2, in details, the first terminal pair 130 further comprises a first pivotal axis 135, which pivotally connects the first base 131 and the first positive electrode 133, so that the first positive electrode 133 can be rotated between the first direction D1 and the second direction D2 via the first pivotal axis 135. The first positive electrode 133 can be freely rotated between the first direction D1 and the second direction D2. Before the string-shape circuit board 110 is clipped, the first positive electrode 133 can be folded inwardly to avoid the first positive electrode 133 being protruded and interfering the moving of the cutting tool.

Similarly, the first terminal pair 130 further comprises a second pivotal axis 136 which pivotally connects the second base 132 and the first negative electrode 134, so that the first negative electrode 134 can be rotated between the first direction D1 and the second direction D2 via the second pivotal axis 136. The first negative electrode 134 can be freely rotated between the first direction D1 and the second direction D2. Before the string-shape circuit board 110 is clipped, the first negative electrode 134 can be folded inwardly to avoid the first negative electrode 134 being protruded and interfering the moving of the cutting tool.

The first base 131 and the second base 132 can be formed by a conductive material, and are disposed on the first solder pad 111 and the second solder pad 112 for electrically connecting the first solder pad 111 and the second solder pad 112 respectively. Several wires 115 connect the solder pad (the first solder pad 111 and the second solder pad 112) and the light-emitting elements 120, so that the first positive electrode 133 is electrically connected to the light-emitting elements 120 through the first base 131, the first solder pad 111 and the wire 115, and the first negative electrode 134 is electrically connected to the light-emitting elements 120 through the second base 132, the second solder pad 112 and the wire 115. The wire 115, the first solder pad 111, and the second solder pad 112 can be pre-formed on the string-shape circuit board 110 by way of electroplating or other material to reduce the manual soldering process during assembly.

The first base 131 and the first positive electrode 133 have an upper surface 131u and an upper surface 133u respectively. The upper surface 133u of the first positive electrode 133 is higher than or aligned with the upper surface 131u of the first base 131, so that the suction nozzle (not illustrated) can conveniently suck the first positive electrode 133 during the surface-mount technology (SMT). The second base 132 and the first negative electrode 134 have a similar feature, and the similarities are not repeated here.

The second terminal pair 140 is disposed on the first surface 110s1 of the second side 110e2 of the string-shape circuit board 110 by using the surface mounting technology, and is electrically connected to the light-emitting elements 120. The second terminal pair 140 comprises a third base 141, a fourth base 142, a second positive electrode 143 and a second negative electrode 144. The second positive electrode 143 and the second negative electrode 144 are pivotally connected to the third base 141 and the fourth base 142 respectively and can be freely rotated between the first direction D1 and the second direction D2. To put it in greater details, the second terminal pair 140 further comprises a third pivotal axis 145 via which the second positive electrode 143 can be rotated between the first direction D1 and the second direction D2. The second positive electrode 143 and the second negative electrode 144 can be freely rotated between the first direction D1 and the second direction D2. Before the string-shape circuit board 110 is clipped, the second positive electrode 143 can be folded inwardly to avoid the second positive electrode 143 being protruded and interfering the moving of the cutting tool.

Similarly, the second terminal pair 140 further comprises a fourth pivotal axis 146 via which the second negative electrode 144 can be rotated between the first direction D1 and the second direction D2. The second negative electrode 144 can be freely rotated between the first direction D1 and the second direction D2. Before the string-shape circuit board 110 is clipped, the string-shape circuit board 110, the second negative electrode 144 can be folded inwardly to avoid the second negative electrode 144 being protruded and interfering the moving of the cutting tool.

The third base 141 and the fourth base 142 can be formed by a conductive material, and are respectively disposed on the third solder pad 113 and the fourth solder pad 114 for electrically connecting the third solder pad 113 and the fourth solder pad 114 respectively. Several wires 115 connect the solder pads (the third solder pad 113 and the fourth solder pad 114) and light-emitting elements 120, so that the second positive electrode 143 is electrically connected to the light-emitting elements 120 through the third base 141, the third solder pad 113 and the wire 115, and the second negative electrode 144 is electrically connected to the light-emitting elements through the fourth base 142, the fourth solder pad 114 and the wire 115. The third solder pad 113 and the fourth solder pad 114 can be pre-formed on the string-shape circuit board 110 by way of electroplating or other material to reduce the manual soldering process during assembly.

The third base 141 and the second positive electrode 143 have an upper surface 141u and an upper surface 143u, respectively. The upper surface 143u of the second positive electrode 143 is higher than or aligned with the upper surface 141u of the third base 141, so that the suction nozzle (not illustrated) can conveniently suck the second terminal pair 140 during the SMT. The fourth base 142 and the second negative electrode 144 have a similar feature, and the similarities are not repeated here.

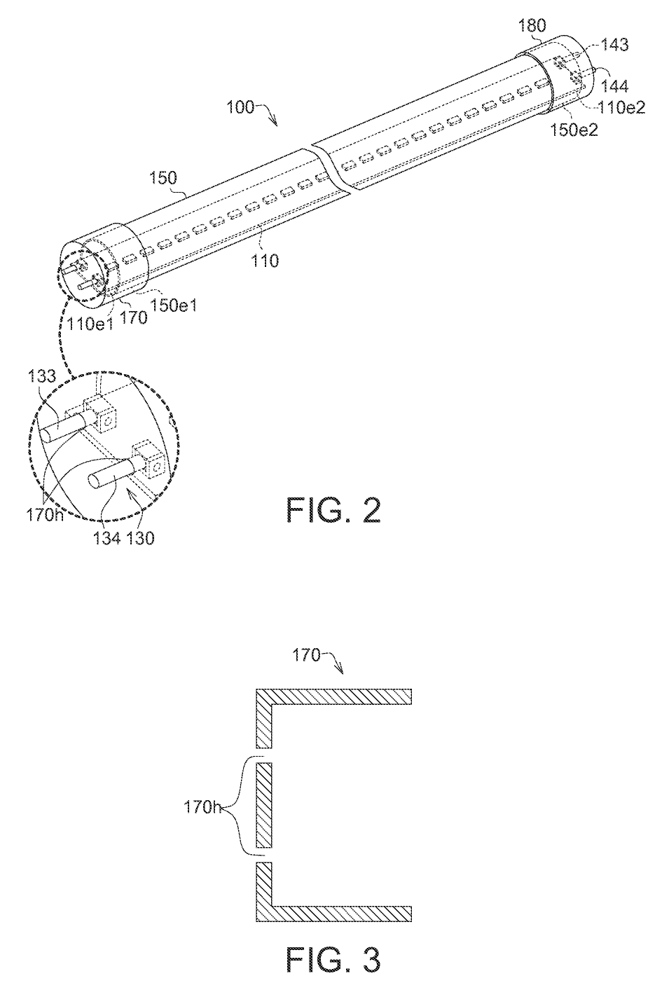

Two ends of the transparent hollowed tube 150 are a first terminal end 150e1 and a second terminal end 150e2 respectively. The string-shape circuit board 110 is disposed in the transparent hollowed tube 150. The first side 110e1 and the second side 110e2 of the string-shape circuit board 110 correspond to the first terminal end 150e1 and the second terminal end 150e2 respectively (as illustrated in FIG. 2).

The drive power 160 is electrically connected between the light-emitting elements 120 and the first terminal pair 130 and/or the second terminal pair 140 for controlling the light-emitting mode of the light-emitting elements 120.

FIG. 2 is an assembly diagram of FIG. 1. The first end cap 170 and the second end cap 180 are detachably mounted on the first terminal end 150e1 and the second terminal end 150e2 respectively for mounting the transparent hollowed tube 150. The first end cap 170 has a first hole pair 170h via which the first terminal pair 130 penetrates the first end cap 170. Similarly, the second end cap 180 has a second hole pair (cannot be seen due to the problem of view angle) via which the second terminal pair 140 penetrates the second end cap 180.

FIG. 3 is a cross-sectional view of the first end cap of FIG. 2. In an embodiment, the first end cap 170 can be formed by an insulating material (such as plastics) by way of injection. Since the first terminal pair 130 is integrated with the first base 131 outside the first end cap 170, the structure of the first end cap 170 is much simplified, and design complexity is largely reduced. The structure of the second end cap 180 is similar to that of the first end cap 170, and the similarities are not repeated here.

While the invention has been described by way of example and in terms of the preferred embodiment(s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A light-emitting device, comprising:
a string-shape circuit board having a first side and a second side, wherein a first surface and a second surface parallel and opposite to each other are disposed between the first side and the second side, wherein a center of the circuit substrate extending towards the first side is defined as a first direction, and the center of the circuit substrate extending toward the second side is defined as a second direction;
a plurality of light-emitting elements disposed on the first surface of the string-shape circuit board; and
a first terminal pair and a second terminal pair respectively disposed on the first surface of the first side and the second side of the string-shape circuit board and electrically connected to the light-emitting elements, wherein the first terminal pair comprises a first base, a second base, a first positive electrode and a first negative electrode, the first positive electrode and the first negative electrode are pivotally connected to the first base and the second base respectively and able to be freely rotated between the first direction and the second direction, the second terminal pair comprises a third base, a fourth base, a second positive electrode and a second negative electrode, and the second positive electrode and the second negative electrode are pivotally connected to the third base and the fourth base respectively and able to be freely rotated between the first direction and the second direction.

2. The light-emitting device according to claim 1, wherein the first base, the second base, the third base and the fourth base comprise a first pivotal axis, a second pivotal axis, a third pivotal axis and a fourth pivotal axis respectively, so that the first positive electrode, the first negative electrode, the second positive electrode and the second negative electrode are rotated between the first direction and the second direction via the plurality of pivotal axes.

3. The light-emitting device according to claim 2, wherein a first solder pad, a second solder pad, a third solder pad and a fourth solder pad are disposed under the first base, the second base, the third base and the fourth base respectively for electrically connecting the light-emitting elements to the first positive electrode, the first negative electrode, the second positive electrode and the second negative electrode respectively.

4. The light-emitting device according to claim 3, further comprising a drive power electrically connected between the light-emitting elements, the first terminal pair and the second terminal pair, between the light-emitting elements and the first terminal pair, or between the light-emitting elements and the second terminal pair.

5. The light-emitting device according to claim 4, wherein the light-emitting elements are light-emitting diodes (LEDs).

6. The light-emitting device according to claim 1, further comprising a transparent hollowed tube whose two ends are a first terminal end and a second terminal end respectively, wherein the string-shape circuit board is disposed inside the transparent hollowed tube, and the first side and the second side of the string-shape circuit board correspond to the first terminal end and the second terminal end respectively.

7. The light-emitting device according to claim 2, further comprising a transparent hollowed tube whose two ends are a first terminal end and a second terminal end respectively, wherein the string-shape circuit board is disposed inside the transparent hollowed tube, and the first side and the second side of the string-shape circuit board correspond to the first terminal end and the second terminal end respectively.

8. The light-emitting device according to claim 3, further comprising a transparent hollowed tube whose two ends are a first terminal end and a second terminal end respectively, wherein the string-shape circuit board is disposed inside the transparent hollowed tube, and the first side and the second side of the string-shape circuit board correspond to the first terminal end and the second terminal end respectively.

9. The light-emitting device according to claim 4, further comprising a transparent hollowed tube whose two ends are a first terminal end and a second terminal end respectively, wherein the string-shape circuit board is disposed inside the transparent hollowed tube, and the first side and the second side of the string-shape circuit board correspond to the first terminal end and the second terminal end respectively.

10. The light-emitting device according to claim 5, further comprising a transparent hollowed tube whose two ends are a first terminal end and a second terminal end respectively, wherein the string-shape circuit board is disposed inside the transparent hollowed tube, and the first side and the second side of the string-shape circuit board correspond to the first terminal end and the second terminal end respectively.

11. The light-emitting device according to claim 6, further comprising a first end cap and a second end cap detachably mounted on the first terminal end and the second terminal end, respectively, wherein the first end cap and the second end cap have a first hole pair and a second hole pair through which the first terminal pair and the second terminal pair penetrate the first end cap and the second end cap respectively.

12. The light-emitting device according to claim 7, further comprising a first end cap and a second end cap detachably mounted on the first terminal end and the second terminal end, respectively, wherein the first end cap and the second end cap have a first hole pair and a second hole pair through which the first terminal pair and the second terminal pair penetrate the first end cap and the second end cap respectively.

13. The light-emitting device according to claim 8, further comprising a first end cap and a second end cap detachably mounted on the first terminal end and the second terminal end, respectively, wherein the first end cap and the second end cap have a first hole pair and a second hole pair through which the first terminal pair and the second terminal pair penetrate the first end cap and the second end cap respectively.

14. The light-emitting device according to claim 9, further comprising a first end cap and a second end cap detachably mounted on the first terminal end and the second terminal end, respectively, wherein the first end cap and the second end cap have a first hole pair and a second hole pair through which the first terminal pair and the second terminal pair penetrate the first end cap and the second end cap respectively.

15. The light-emitting device according to claim 10, further comprising a first end cap and a second end cap detachably mounted on the first terminal end and the second terminal end, respectively, wherein the first end cap and the second end cap have a first hole pair and a second hole pair through which the first terminal pair and the second terminal pair penetrate the first end cap and the second end cap respectively.
